(19) United States
(12) Patent Application Publication
(10) Pub. No.: US 2015/0223517 A1
(43) Pub. Date: Aug. 13, 2015

(54) PROCESS FOR USING TOBACCO

(71) Applicant: Kind Consumer Limited, London, Greater London (GB)

(72) Inventors: Alex Hearn, London (GB); Ritika Gupta, London (GB); Stuart Bhimsen Lowe, Oxford (GB); Hon Kit Chan, Sidcup (GB)

(21) Appl. No.: 14/416,506

(22) PCT Filed: Jul. 12, 2013
(86) PCT No.: PCT/GB2013/051868

§ 371 Date: Jan. 22, 2015

(30) Foreign Application Priority Data
Jul. 13, 2012 (GB) 1212532.4

(51) Int. Cl. A24B 15/26; C08G 63/183; C08G 63/78; A24B 15/16; A24B 15/24

(52) U.S. Cl. CPC A24B 15/26; A24B 15/16; A24B 15/243; C08G 63/78; C08G 63/183

(57) ABSTRACT

The present invention relates to processes for deriving components or products from tobacco biomass. In particular the invention relates to a process for deriving two or more components or products from a single tobacco biomass stock, wherein during the process, at least one component or product, for example nicotine, is extracted from a liquid phase and at least one component or product, for example an organic molecule such as an alcohol, is produced from a solid phase. The invention also relates to products, particularly plastics, synthesised from the organic molecules derived from the biomass stock.

The present invention relates to processes for deriving components or products from tobacco biomass. In particular the invention relates to a process for deriving two or more components or products from a single tobacco biomass stock, wherein during the process, at least one component or product, for example nicotine, is extracted from a liquid phase and at least one component or product, for example an organic molecule such as an alcohol, is produced from a solid phase. Any organic molecules produced are preferably used for the production of polymers that can be incorporated into plastics.

### BACKGROUND

Tobacco smoking is a common activity due to the stimulant effects of nicotine, and the fact that nicotine is a highly addictive substance. However, the other components of tobacco smoke such as carbon monoxide and tar are severely detrimental to human health. In view of the health risks, the trend towards tobacco smoking has declined in some countries and the demand for products that can deliver nicotine alone has increased. A number of nicotine replacement therapies have been developed including nicotine skin patches, nicotine-containing gums, nicotine cartridges, and nicotine inhalers. Furthermore, simulated smoking devices promise to mimic the activity of smoking and have the potential to replace the consumption of combustible tobacco products with harm-reduced alternatives over the next 20 years.

The nicotine for these replacement therapies and smoking devices can be obtained by processing tobacco biomass to produce a purified form of nicotine. Standard methods for the extraction of nicotine from tobacco plants are described in U.S. Pat. No. 896,124, U.S. Pat. No. 1,823,554 and U.S. Pat. No. 2,128,043.

Plant-derived biomass is a valuable renewable resource and can be used to produce organic molecules, such as ethanol or “bioethanol”, which can be utilised as biofuels or used as precursors to produce materials such as bio-plastics and products made therefrom. Lignocellulosic materials are the most abundant plant biomass resource. The cellulose and hemicellulose fractions of this material can be hydrolysed to sugars, such as glucose and xylose, which can then be converted to ethanol by fermentation. A difficulty associated with using lignocellulosic plant material is that the cellulose and hemicellulose are densely packed by lignin layers, which protect them against enzyme hydrolysis. As such, the material must undergo a “pre-treatment” step in order to disrupt the structure of the lignocellulosic biomass and facilitate subsequent hydrolysis of the material by cellulases and hemicellulases. Various pre-treatment methods have been investigated including the use of high temperature, pressure explosions, use of acids and alkalis and addition of various other chemicals. The use of dilute acid solutions is typically preferred due to the lower cost of acid. Exemplary processes for producing alcohols from plant lignocellulose biomass are described in US2010/0143974 and WO2012/047832.

Companies that require a large amount of packaging material have begun to derive their plastics from plant biomass. For example, the Coca-Cola PlantBottle, subject of US2009/0246430, uses biomass from plants such as sugarcane. In a renewable packaging developed by PepsiCo, agricultural waste products such as corn husks are used as sources of biomass.

The tobacco plant has previously been described as a source of lignocellulosic biomass for the production of fuel ethanol. In C. Martin et al., World J. Microb. Biot. 2002, 18, 857, a process is described in which tobacco stalks pre-treated by steam explosion are exposed to cellulase enzymes and the hydrolysate is subsequently fermented to yield ethanol. In G. Shen et al., J. Food Process Eng. 2011, 34, 905, the authors report on a study carried out to investigate the effects of different pre-treatment conditions on the efficiency of subsequent enzymatic hydrolysis of cellulose in tobacco stems. The inclusion of hydrogen peroxide was found to give a higher recovery of cellulose and better removal of lignin and hemicellulose than alkali-only pre-treatment. This gave rise to an increase in the yield of fermentable sugar produced from the biomass.

### SUMMARY OF INVENTION

The present invention is founded on the observation that existing processes for the extraction of components or products in a liquid phase from tobacco plants, in particular nicotine extraction processes, generate extremely large quantities of residual solid material, which is typically regarded as “waste”. In addition, processing of tobacco plants to recover the leaves for use in smoking articles leaves behind plant-based material including stems, stalks and roots.

Considering the tobacco plant as a whole, it typically contains less than 2% w/w nicotine by dry weight. The remainder comprises lignocellulosic material which would be suitable for processing to produce value-added products. The recovery of value-added products has only recently begun to be considered in respect of the tobacco plant, mainly because of the historically high value of tobacco leaves when used in smoking articles. However, as the market for these smoking articles decreases, it will become more important to derive value from those components previously considered “waste”.

Nicotine extraction processes typically yield a liquid phase comprising nicotine and a solid component comprising lignocellulosic matter. Due to the caustic solutions and organic solvents used for the extraction process, some of the waste produced is toxic. Moreover, the solid matter is typically considered a waste product and is recycled or sold to farmers as fertiliser.

Furthermore, in some nicotine extraction processes, for example as described in US896,124, the aim is to preserve the integrity of the tobacco leaf such that the tobacco leaves can subsequently be used in smoking applications. Such processes do not sufficiently disrupt the structure of lignin for effective hydrolysis of polysaccharides.

As described above, the use of plant cellulosic matter as a renewable resource for the generation of organic precursors for the production of bio-based materials and products including biofuels and bioplastics is of increasing interest due to the environmental benefits of such products. However, the present inventors have noted that existing methods of obtaining organic molecules, such as ethanol, from tobacco biomass employ a pre-treatment step which, whilst very effective at disrupting the structure of the biomass, causes a significant solubilisation of the hemicellulose fraction of the plant material. These solubilised sugars and sugar polymers serve to contaminate any liquid fraction produced therefore such methods have never before been used for the combined extraction of water-soluble molecules of interest, such as nicotine. Furthermore, US2002/0197688 teaches a method for producing ethanol by fermentation, using a reduced nicotine recombinant tobacco plant as the biomass source, which again reduces the potential for the production of multiple components from the biomass.

It is therefore an object of the present invention to provide a process in which a tobacco biomass stock can be used to derive more than one useful substance or product.

In a first aspect, provided herein is a process for deriving two or more components or products from tobacco biomass stock, wherein at least one component or product is extracted from a liquid phase, and at least one component or product is produced from a solid phase, wherein said process comprises the steps of:

(a) treating the biomass stock with an aqueous alkali solution to produce a liquid phase and a solid phase containing undissolved tobacco cellulosic material;
(b) separating the liquid phase from the solid phase;
(c) extracting the at least one component or product from the liquid phase by liquid-liquid or solid phase extraction;
(d) contacting the solid phase with one or more enzymes capable of hydrolyzing the cellulosic material to produce fermentable sugars; and
(e) fermenting the fermentable sugars to produce the at least one component or product from the solid phase.

Preferably, the component or product extracted from the liquid phase is a water-soluble component or product, optionally selected from the group consisting of alkaloids, citric acids, pectins, carotenoids, pectinases, fraction 1 proteins, fraction 2 proteins, and phenolic compounds. Alternatively, or in addition, the component or product produced from the solid phase is an organic molecule selected from the group consisting of:—alcohols, aldehydes, alkanes, alkenes, benzoic compounds, carboxylic acids, ketones, polyols. In a particularly preferred embodiment of the invention, the component or product extracted from the liquid phase is nicotine and the component or product produced from the solid phase is ethanol.

Any organic molecules produced by the process of the present invention may be used for any suitable downstream application. In preferred embodiments of the invention, the process is used to produce organic molecules, such as ethanol, that can be used to produce bio-based plastics. As used herein, the term “bio-plastic” is intended to mean any plastic comprising polymers derived from a bio-based material including but not limited to alcohols, aldehydes, alkanes, alkenes, benzoic compounds, carboxylic acids, ketones or polyols derived from plant biomass. Bio-plastics are of increasing interest because they represent an important alternative to plastics derived from non-renewable natural resources such as oil.

Bio-plastics produced from tobacco biomass using the process of the present invention may be used to manufacture a range of different products. In preferred embodiments of the invention, the bio-plastic produced is used in the manufacture of nicotine-containing products. Nicotine-containing products include nicotine inhalers, such as the simulated smoking device described in WO2011/095781.

As noted above, as tobacco smoking declines, the trend for nicotine replacement products, such as nicotine cartridges, nicotine inhalers and simulated smoking devices grows. However, many of these products require large quantities of plastic packaging and/or incorporate large quantities of plastic in their design. The process of the present invention allows for both the nicotine and an organic precursor of the plastic needed for plastic-containing nicotine replacement therapies and devices to be derived at least in part from the same tobacco biomass stock.

Therefore, in a second aspect of the invention, provided herein is a nicotine replacement product comprising nicotine and a plastic synthesised at least in part from one or more organic precursors, wherein both the nicotine and at least one organic precursor are derived from the same tobacco biomass stock.

In an additional environmental benefit, the present invention would represent a more effective use of the arable land currently used for cultivation of tobacco, by deriving useful products, in addition to nicotine or smoking tobacco, from tobacco plants.

### BRIEF DESCRIPTION OF THE DRAWINGS

FIG. 1. Schematic representation of a process for the extraction of nicotine and the production of ethanol from a single tobacco biomass stock.

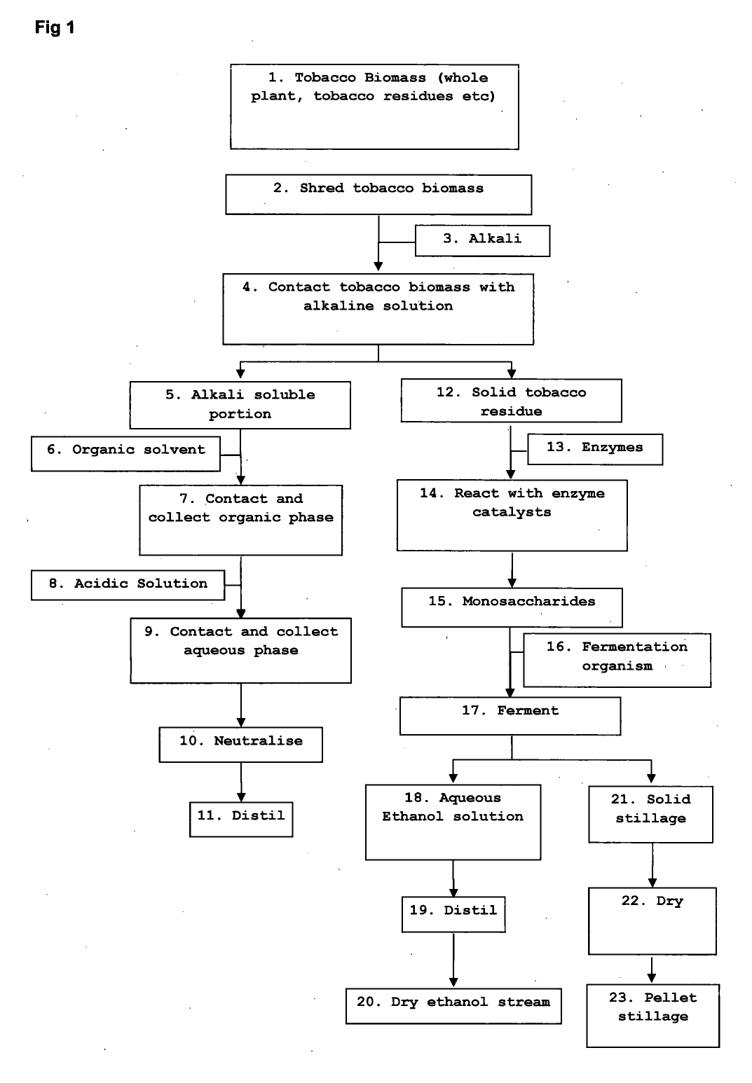

### DETAILED DESCRIPTION

The present invention provides a process for deriving two or more components or products from tobacco biomass stock wherein at least one component or product is extracted from a liquid phase, and at least one component or product is produced from a solid phase. The process therefore allows the two or more components or products to be obtained from the same starting material i.e. the tobacco biomass stock.

As used herein, the term “tobacco biomass” is intended to mean biomass derived from any plant of the Nicotiana genus, including but not limited to N. tabacum, N. rustica and N. glutinosa. Examples of specific tobacco varieties which may be used include: brightleaf, burley, cavendish, corojo, criollo, oriental, perique, petite Havana, Samsun NN, SR1, thuoc lao, type 22, virginia, white burley, wild tobacco, Xanthi, and Y1. The biomass may derive from the whole plant or any part thereof, including but not limited to leaves, buds, flowers, stems, stalks, roots, or combinations thereof. The biomass may comprise unmanufactured tobacco, tobacco refuse, air cured tobacco, fire cured tobacco, flue cured tobacco, sun cured tobacco or combinations thereof.

A “tobacco biomass stock” or “tobacco biomass feedstock” should be taken to mean a defined quantity of biomass for use as the starting material in the process of the present invention. The tobacco biomass stock has a dry mass comprising at least 0.1% w/w nicotine and can be derived from tobacco biomass. It may however, additionally comprise non-tobacco sources, such as corn stover, switch grass, sugar beet, sugarcane bagasse, wheat bagasse and agricultural waste of any sort.

In a preferred embodiment, the tobacco biomass stock has a dry mass comprising at least 0.1% w/w nicotine and at least 25% w/w cellulose. In a further preferred embodiment, the tobacco biomass stock has a dry mass comprising at least 25% w/w cellulose, at least 15% w/w hemicellulose, at least 10% w/w lignin, and at least 0.1% w/w nicotine.

Tobacco biomass may be obtained via any standard harvesting technique. The biomass or biomass stock may be washed prior to treatment with alkali to remove any residual soil and/or water-soluble non-systemic agents used during cultivation. In addition, the tobacco biomass or biomass stock may be reduced in size to pieces of less than 15 mm across in all dimensions, preferably less than 10 mm across in all dimensions to allow for better access of reagents used in the subsequent steps of the process. Any suitable method of size reduction may be used including but not limited to chipping, chopping, cutting, milling, pulverising and shredding.

Alternatively or in addition to washing and/or size reduction, the tobacco biomass stock for use in the process of the present invention may have been pre-processed, for example to remove or extract certain products or components prior to treatment. In certain embodiments of the invention, the biomass stock will have been pre-processed so as to remove at least one oil-soluble component or product, optionally selected from solanesol and polyprenols. Such a pre-processing step may involve soaking the biomass stock in a weak alkali solution for a defined period prior to carrying out steps (a) to (e) of the process set forth below.

The process of the present invention comprises the steps of:—

(a) treating the biomass stock with an aqueous alkali solution to produce a liquid phase and a solid phase containing undissolved tobacco cellulosic material;
(b) separating the liquid phase from the solid phase;
(c) extracting the at least one component or product from the liquid phase by liquid-liquid or solid phase extraction;
(d) contacting the solid phase with one or more enzymes capable of hydrolyzing the cellulosic material to produce fermentable sugars; and
(e) fermenting the fermentable sugars to produce the at least one component or product from the solid phase.

### Treating the Biomass Stock

As a first step in the process of the present invention, the biomass stock is treated with an aqueous alkali solution under conditions that allow for the dissolution of soluble components in the biomass while simultaneously disrupting the lignocellulose structure of the biomass.

This treatment step gives rise to a liquid phase comprising soluble components of the tobacco biomass stock and a solid phase containing undissolved tobacco cellulosic material. The soluble components of the biomass stock may be water-soluble components as described in further detail below.

It is important that, during treatment, the lignin is sufficiently degraded so as to allow hydrolysis of the undissolved tobacco cellulosic material by enzymes such as cellulases and hemicellulases in a subsequent step of the process. The process of the present invention typically removes at least 30% of the lignin present in the biomass. The conditions during the treatment step are preferably such that the solubilisation and subsequent loss of sugar polymers (such as cellulose and hemicellulose) to the liquid phase is minimised. It is important that as much as possible of the sugar-containing fraction of the tobacco biomass stock is maintained in the solid phase during treatment of the biomass stock for the downstream processing steps, including hydrolysis and fermentation.

The aqueous alkali solution may have a concentration of between about 0.01 M and about 2.0 M, preferably between about 0.1 M and about 1.0 M. Any suitable alkali solution may be used. Examples of alkali useful for the process of the present invention include but are not limited to ammonia, ammonium hydroxide, calcium hydroxide, calcium oxide, potassium hydroxide and sodium hydroxide. In a preferred embodiment, the alkali solution is a sodium hydroxide solution having a concentration of between about 0.1 M and about 1.0 M, preferably 0.5 M.

In a preferred embodiment, the alkali solution is added to the biomass so as to achieve a final dilution of between about 5% w/w and about 25% w/w solid content, preferably between about 10% w/w and about 20% w/w, more preferably about 12% w/w solid content.

In the first step of the process, the biomass-alkali solution may be treated at a temperature of between about 100° C. and about 200° C., preferably between about 100° C. and about 150° C. or any temperature there between including but not limited to 100, 105, 110, 115, 120, 125, 130, 135, 140, 145 or 150° C., for a period of time of between about 2 minutes and about 120 minutes, preferably between about 2 minutes and about 20 minutes, preferably between about 6 minutes and about 20 minutes or any time there between including but not limited to 6, 8, 10, 12, 14, 16, 18 or 20 minutes. The temperature of the solution may then be reduced to between about 25° C. and about 50° C. for ease of subsequent handling of the treated material.

In one embodiment, the treatment is carried out in a pressure vessel and the biomass-alkali solution is agitated during treatment.

### Separating the Liquid Phase and Solid Phase

Once the biomass stock has been treated with the aqueous alkali solution, two phases are generated: a liquid phase comprising the alkali solution with soluble components or products or water-soluble products from the tobacco biomass stock present therein, and a treated solid phase containing undissolved tobacco cellulosic material. These phases may be separated by any suitable technique known to one skilled in the art. For example, the liquid-solid separation step may be carried out using any of the following singly or in combination: centrifuges, filter cloths, filter paper, filter presses, fritted funnels, membranes, meshes, screen filters, separation funnels, sieves or skimmers. The separation techniques may use gravitational flow, centrifugal force or externally applied pressure.

The treated solid phase can be defined in comparison with the original biomass stock. The treated solid phase will have a reduced content of nicotine, polysaccharides and lignin (when compared to the original biomass stock). The treated solid phase will preferably have a nicotine reduction of at least 70%, a polysaccharide reduction of less than 20% and a lignin reduction of at least 30% (when compared to the original biomass stock).

The components or products derivable from the liquid phase typically include alkaloids, carotinoids, citric acids, fraction 1 proteins, fraction 2 proteins, lignin, nicotine, pectinases, pectins and phenolic compounds. In certain embodiments, it is an object of the process of the present invention to extract or isolate at least one water-soluble component or product selected from the group comprising alkaloids, carotinoids, citric acids, fraction 1 proteins, fraction 2 proteins, lignin, nicotine, pectinases, pectins, phenolic compounds or an oil-extractable compound from the group comprising polyprenols and solanesol. In a preferred embodiment of the invention, the water-soluble component to be extracted is nicotine.

In one embodiment of the invention, the liquid phase is separated from the solid phase by filtering the alkali-treated biomass, preferably by filtering through layers of filter cloths. The solid phase containing the undissolved tobacco cellulosic material may subsequently be washed, for example with water. The washing may be repeated one or more times as required, so as to recover in the liquid phase as much of the desired soluble component from the biomass stock as possible.

### Extracting a Soluble Component

A soluble component or product of interest, preferably a water-soluble component or product, may be extracted from the liquid phase by any suitable liquid-liquid or solid phase extraction technique. In certain embodiments, the extraction of target products from the liquid phase may be achieved by contacting the liquid with organic solvent. Suitable organic solvents include but are not limited to long carbon chain hydrocarbons, such as hexane, kerosene, paraffin and toluene or mixtures thereof. The organic-aqueous mixture may be centrifuged or allowed to settle under gravity to effect phase separation. The organic phase may be separated by separation funnels or removed from the reaction vessel by pumping or gravity. Optionally, further processing of the aqueous phase collected may be carried out to extract remaining soluble or water-soluble components or to recycle back components into the process at the fermentation stage or any other stage of the process. The organic phase may be subsequently contacted with an acidified solution at a pH 1.0-7.0. Suitable acids include but are not limited to acetic acid, citric acid, hydrochloric acid, phosphoric acid or sulphuric acid. The organic-aqueous mixture may be centrifuged or allowed to settle under gravity to effect phase separation. The organic phase may be separated by separation funnels or removed from the reaction vessel by pumping or gravity. The organic phase may then optionally be recovered and recycled for use in the process. The acidified solution containing the target product(s) may optionally be neutralised using any suitable base. Examples of suitable bases include but are not limited to ammonia, calcium carbonate and sodium carbonate. Alternatively, the target component or product, may be concentrated and sold at this point without the need for neutralisation and further purification to provide a concentration of at least 40% target soluble molecule. The neutralised aqueous phase may then be optionally further purified to provide a purity of 90-99.9%, preferably 95-99.9%, even more preferably 98-99.9% using the following methods which are not exhaustive: distillation to recover fractions containing target compounds, for example using distillation at atmospheric pressure followed by vacuum distillation or using high pressure steam distillation.

Alternatively the target components or products, preferably water-soluble products, may be extracted from the liquid phase using solid-phase extraction or supercritical fluid extraction, for example through the use of chromatographic columns for solid phase extraction and supercritical carbon dioxide for supercritical fluid extraction.

Wherein the soluble component or product to be extracted is nicotine, the extraction may be carried out by contacting the liquid phase with paraffin, centrifuging the mixture, collecting the paraffin-containing phase and contacting with 0.1 M sulphuric acid, centrifuging the mixture, collecting the sulphuric acid-containing phase and neutralising with alkali, distilling at about 125° C. until the water is removed, vacuum distilling at about 125° C. and about 1.6 kPa, and collecting the distillate containing the nicotine.

The yield of nicotine, calculated with respect to the w/w percentage of nicotine contained in the dry biomass, will typically be at least 70%, preferably at least 80%, more preferably at least 90%. The process of the invention will typically yield nicotine having a purity of at least 40%, preferably at least 95%, more preferably at least 99% purity.

### Hydrolysing the Cellulosic Material

The solid phase obtained from the liquid phase-solid phase separation is treated with hydrolytic enzymes capable of converting the cellulosic material within the solid phase into fermentable sugars. As used herein, the term “fermentable sugars” should be taken to mean any oligosaccharide or monosaccharide that can be used as a carbon source by a microorganism in a fermentation process.

The solid phase obtained from the liquid phase-solid phase separation may optionally be autoclaved prior to contacting with hydrolytic enzymes. In one embodiment, the solid phase is autoclaved at about 121° C. for about 15 minutes prior to contacting with the hydrolytic enzymes. The solid phase may be diluted in solution to between about 5% w/w and about 25% w/w, preferably between about 10% w/w and 20% w/w.

As used herein, the term “hydrolytic enzymes” should be taken to mean any enzymes or mixture of enzymes capable of hydrolyzing hemicellulose (hemicellulases) and/or cellulose (cellulases). Cellulase enzymes may include the following types of enzymes: endoglucanases, exocellulases, and cellobioases. Hemicellulases include xylanases, galactosidases, mannases, arabinases amongst others. For example suitable commercial enzymes include but are not limited to cellic Ctec2®, cellic Ctec 3®, cellic Htec 2®, cellic Htec3® (Novozymes Bagsvaerd, Denmark), accellerase Duet®, accellerase Trio® (Genencor Palo Alto, Calif. USA), celu star CL, celu star XL, cellulase plus, xylanase plus (Dyadic Jupiter, Fla. USA). For the present process the enzymes used can be from any source, examples of suitable sources include but are not limited to the genera Aspergillus and Trichoderma. The cellulase and hemicellulase dosage for the reaction is dependent on the ability of the specific strains of enzymes to convert cellulose and hemicellulose to fermentable sugars, for example the range can be from a ratio of about 1:20 to about 1:5 w/w of enzymes to solid biomass, with ratios of cellulase:hemicellulase determined dependent on specific type of biomass used, for example about 1:5-5:1 ratio of cellulase:hemicellulase.

The pH and temperature of the solid phase is typically adjusted during the hydrolysis step of the process so that it is within a range which is optimal for the hydrolytic enzymes used. In one embodiment, the pH of the solid phase is adjusted to within a range of about pH 2.0 to about pH 8.0, preferably within a range of about pH 2.0 to about pH 7.0, more preferably within a range of about pH 4.0 to about pH 6.0, or any pH there between. Alternatively, or in addition, the temperature may be in the range of about 30° C. to about 75° C., preferably in the range of about 40° C. to about 60° C., or any temperature there between including but not limited to 40, 45, 50, or 55° C. The solid phase may be mixed with the enzymes in any suitable buffer known to those skilled in the art including but not limited to citrate buffers and phosphate buffers. In a preferred embodiment, the solid phase is contacted with hydrolytic enzymes in the presence of about 0.1 M citrate buffer at the desired pH and temperature so that the solid component of the mixture does not exceed 20% w/w. The w/w ratio of enzymes to solid component may be from 1/20 to 1/5.

The solid phase may be contacted with the hydrolytic enzymes for any suitable length of time in order to achieve conversion of the cellulosic material into fermentable sugars. Fermentable sugars may include: glucose, xylose, galactose, arabinose, fructose, glucuronic acid, mannose or any oligosaccaride form of these monosaccharides.

In a preferred embodiment of the invention, at least 50%, preferably at least 60%, more preferably at least 70%, 80% of the polysaccharides will be degraded, and the resulting degradation products comprising fermentable sugars may be recovered in the hydrolysate using the process described herein.

In one embodiment, the mixture is incubated for a period of between about 0.5 and about 5 days, optionally with stirring.

### Fermentation

After enzyme hydrolysis, the hydrolysate containing the fermentable sugars is fermented to produce at least one component or product, typically an organic molecule. The hydrolysate may be diluted prior to use in fermentation. Fermentation may be carried out by the addition of any naturally-occurring or genetically modified microorganisms capable of converting the fermentable sugars to organic molecules. As used herein the term “organic molecule” should be taken to mean a molecule selected from the group consisting of: alcohols, aldehydes, alkanes, alkenes, benzoic compounds, carboxylic acids, ketones or polyols. For example alcohols such as ethanol and butanol, polyols such as butandiol and propandiol, alkanes such as methane, alkenes such as ethylene and propylene and carbolxylic acids such as citric acid and lactic acid can be produced. In certain embodiments, the organic molecule may be selected from the group consisting of:—methane, methanol, ethane, ethene, ethanol, n-propane, 1-propene, 1-propanol, propanal, acetone, propionate, n-butane, 1-butene, 1-butanol, butanal, butanoate, isobutanal, isobutanol, 2-methylbutanal, 2-methylbutanol, 3-methylbutanal, 3-methylbutanol, 2-butene, 2-butanol, 2-butanone, 2,3-butanediol, 3-hydroxy-2-butanone, 2,3-butanedione, ethylbenzene, ethenylbenzene, 2-phenylethanol, phenylacetaldehyde, 1-phenylbutane, 4-phenyl-1-butene, 4-phenyl-2-butene, 1-phenyl-2-butene, 1-phenyl-2-butanol, 4-phenyl-2-butanol, 1-phenyl-2-butanone, 4-phenyl-2-butanone, 1-phenyl-2,3-butandiol, 1-phenyl-3-hydroxy-2-butanone, 4-phenyl-3-hydroxy-2-butanone, 1-phenyl-2,3-butanedione, n-pentane, ethylphenol, ethenylphenol, 2-(4-hydroxyphenyl)ethanol, 4-hydroxyphenylacetaldehyde, 1-(4-hydroxyphenyl) butane, 4-(4-hydroxyphenyl)-1-butene, 4-(4-hydroxyphenyl)-2-butene, 1-(4-hydroxyphenyl)-1-butene, 1-(4-hydroxyphenyl)-2-butanol, 4-(4-hydroxyphenyl)-2-butanol, 1-(4-hydroxyphenyl)-2-butanone, 4-(4-hydroxyphenyl)-2-butanone, 1-(4-hydroxyphenyl)-2,3-butandiol, 1-(4-hydroxyphenyl)-3-hydroxy-2-butanone, 4-(4-hydroxyphenyl)-3-hydroxy-2-butanone, 1-(4-hydroxyphenyl)-2,3-butanonedione, indolylethane, indolylethene, 2-(indole-3-)ethanol, n-pentane, 1-pentene, 1-pentanol, pentanal, pentanoate, 2-pentene, 2-pentanol, 3-pentanol, 2-pentanone, 3-pentanone, 4-methylpentanal, 4-methylpentanol, 2,3-pentanediol, 2-hydroxy-3-pentanone, 3-hydroxy-2-pentanone, 2,3-pentanedione, 2-methylpentane, 4-methyl-1-pentene, 4-methyl-2-pentene, 4-methyl-3-pentene, 4-methyl-2-pentanol, 2-methyl-3-pentanol, 4-methyl-2-pentanone, 2-methyl-3-pentanone, 4-methyl-2,3-pentanediol, 4-methyl-2-hydroxy-3-pentanone, 4-methyl-3-hydroxy-2-pentanone, 4-methyl-2,3-pentanedione, 1-phenylpentane, 1-phenyl-1-pentene, 1-phenyl-2-pentene, 1-phenyl-3-pentene, 1-phenyl-2-pentanol, 1-phenyl-3-pentanol, 1-phenyl-2-pentanone, 1-phenyl-3-pentanone, 1-phenyl-2,3-pentanediol, 1-phenyl-2-hydroxy-3-pentanone, 1-phenyl-3-hydroxy-2-pentanone, 1-phenyl-2,3-pentanedione, 4-methyl-1-phenylpentane, 4-methyl-1-phenyl-1-pentene, 4-methyl-1-phenyl-2-pentene, 4-methyl-1-phenyl-3-pentene, 4-methyl-1-phenyl-3-pentanol, 4-methyl-1-phenyl-2-pentanol, 4-methyl-1-phenyl-3-pentanone, 4-methyl-1-phenyl-2-pentanone, 4-methyl-1-phenyl-2,3-pentanediol, 4-methyl-1-phenyl-2,3-pentanedione, 4-methyl-1-phenyl-3-hydroxy-2-pentanone, 4-methyl-1-phenyl-2-hydroxy-3-pentanone, 1-(4-hydroxyphenyl)pentane, 1-(4-hydroxyphenyl)-1-pentene, 1-(4-hydroxyphenyl)-2-pentene, 1-(4-hydroxyphenyl)-3-pentene, 1-(4-hydroxyphenyl)-2-pentanol, 1-(4-hydroxyphenyl)-3-pentanol, 1-(4-hydroxyphenyl)-2-pentanone, 1-(4-hydroxyphenyl)-3-pentanone, 1-(4-hydroxyphenyl)-2,3-pentanediol, 1-(4-hydroxyphenyl)-2-hydroxy-3-pentanone, 1-(4-hydroxyphenyl)-3-hydroxy-2-pentanone, 1-(4-hydroxyphenyl)-2,3-pentanedione, 4-methyl-1-(4-hydroxyphenyl)pentane, 4-methyl-1-(4-hydroxyphenyl)-2-pentene, 4-methyl-1-(4-hydroxyphenyl)-3-pentene, 4-methyl-1-(4-hydroxyphenyl)-1-pentene, 4-methyl-1-(4-hydroxyphenyl)-3-pentanol, 4-methyl-1-(4-hydroxyphenyl)-2-pentanol, 4-methyl-1-(4-hydroxyphenyl)-3-pentanone, 4-methyl-1-(4-hydroxyphenyl)-2-pentanone, 4-methyl-1-(4-hydroxyphenyl)-2,3-pentanediol, 4-methyl-1-(4-hydroxyphenyl)-2,3-pentanedione, 4-methyl-1-(4-hydroxyphenyl)-3-hydroxy-2-pentanone, 4-methyl-1-(4-hydroxyphenyl)-2-hydroxy-3-pentanone, 1-indole-3-pentane, 1-(indole-3)-1-pentene, 1-(indole-3)-2-pentene, 1-(indole-3)-3-pentene, 1-(indole-3)-2-pentanol, 1-(indole-3)-3-pentanol, 1-(indole-3)-2-pentanone, 1-(indole-3)-3-pentanone, 1-(indole-3)-2,3-pentanediol, 1-(indole-3)-2-hydroxy-3-pentanone, 1-(indole-3)-3-hydroxy-2-pentanone, 1-(indole-3)-2,3-pentanedione, 4-methyl-1-(indole-3-)pentane, 4-methyl-1-(indole-3)-2-pentene, 4-methyl-1-(indole-3)-3-pentene, 4-methyl-1-(indole-3)-1-pentene, 4-methyl-2-(indole-3)-3-pentanol, 4-methyl-1-(indole-3)-2-pentanol, 4-methyl-1-(indole-3)-3-pentanone, 4-methyl-1-(indole-3)-2-pentanone, 4-methyl-1-(indole-3)-2,3-pentanediol, 4-methyl-1-(indole-3)-2,3-pentanedione, 4-methyl-1-(indole-3)-3-hydroxy-2-pentanone, 4-methyl-1-(indole-3)-2-hydroxy-3-pentanone, n-hexane, 1-hexene, 1-hexanol, hexanal, hexanoate, 2-hexene, 3-hexene, 2-hexanol, 3-hexanol, 2-hexanone, 3-hexanone, 2,3-hexanediol, 2,3-hexanedione, 3,4-hexanediol, 3,4-hexanedione, 2-hydroxy-3-hexanone, 3-hydroxy-2-hexanone, 3-hydroxy-4-hexanone, 4-hydroxy-3-hexanone, 2-methylhexane, 3-methylhexane, 2-methyl-2-hexene, 2-methyl-3-hexene, 5-methyl-1-hexene, 5-methyl-2-hexene, 4-methyl-1-hexene, 4-methyl-2-hexene, 3-methyl-3-hexene, 3-methyl-2-hexene, 3-methyl-1-hexene, 2-methyl-3-hexanol, 5-methyl-2-hexanol, 5-methyl-3-hexanol, 2-methyl-3-hexanone, 5-methyl-2-hexanone, 5-methyl-3-hexanone, 2-methyl-3,4-hexanediol, 2-methyl-3,4-hexanedione, 5-methyl-2,3-hexanediol, 5-methyl-2,3-hexanedione, 4-methyl-2,3-hexanediol, 4-methyl-2,3-hexanedione, 2-methyl-3-hydroxy-4-hexanone, 2-methyl-4-hydroxy-3-hexanone, 5-methyl-2-hydroxy-3-hexanone, 5-methyl-3-hydroxy-2-hexanone, 4-methyl-2-hydroxy-3-hexanone, 4-methyl-3-hydroxy-2-hexanone, 2,5-dimethylhexane, 2,5-dimethyl-2-hexene, 2,5-dimethyl-3-hexene, 2,5-dimethyl-3-hexanol, 2,5-dimethyl-3-hexanone, 2,5-dimethyl-3,4-hexanediol, 2,5-dimethyl-3,4-hexanedione, 2,5-dimethyl-3-hydroxy-4-hexanone, 5-methyl-1-phenylhexane, 4-methyl-1-phenylhexane, 5-methyl-1-phenyl-1-hexene, 5-methyl-1-phenyl-2-hexene, 5-methyl-1-phenyl-3-hexene, 4-methyl-1-phenyl-1-hexene, 4-methyl-1-phenyl-2-hexene, 4-methyl-1-phenyl-3-hexene, 5-methyl-1-phenyl-2-hexanol, 5-methyl-1-phenyl-3-hexanol, 4-methyl-1-phenyl-2-hexanol, 4-methyl-1-phenyl-3-hexanol, 5-methyl-1-phenyl-2-hexanone, 5-methyl-1-phenyl-3-hexanone, 4-methyl-1-phenyl-2-hexanone, 4-methyl-1-phenyl-3-hexanone, 5-methyl-1-phenyl-2,3-hexanediol, 4-methyl-1-phenyl-2,3-hexanediol, 5-methyl-1-phenyl-3-hydroxy-2-hexanone, 5-methyl-1-phenyl-2-hydroxy-3-hexanone, 4-methyl-1-phenyl-3-hydroxy-2-hexanone, 4-methyl-1-phenyl-2-hydroxy-3-hexanone, 5-methyl-1-phenyl-2,3-hexanedione, 4-methyl-1-phenyl-2,3-hexanedione, 4-methyl-1-(4-hydroxyphenyl)hexane, 5-methyl-1-(4-hydroxyphenyl)-1-hexene, 5-methyl-1-(4-hydroxyphenyl)-2-hexene, 5-methyl-1-(4-hydroxyphenyl)-3-hexene, 4-methyl-1-(4-hydroxyphenyl)-1-hexene, 4-methyl-1-(4-hydroxyphenyl)-2-hexene, 4-methyl-1-(4-hydroxyphenyl)-3-hexene, 5-methyl-1-(4-hydroxyphenyl)-2-hexanol, 5-methyl-1-(4-hydroxyphenyl)-3-hexanol, 4-methyl-1-(4-hydroxyphenyl)-2-hexanol, 4-methyl-1-(4-hydroxyphenyl)-3-hexanol, 5-methyl-1-(4-hydroxyphenyl)-2-hexanone, 5-methyl-1-(4-hydroxyphenyl)-3-hexanone, 4-methyl-1-(4-hydroxyphenyl)-2-hexanone, 4-methyl-1-(4-hydroxyphenyl)-3-hexanone, 5-methyl-1-(4-hydroxyphenyl)-2,3-hexanediol, 4-methyl-1-(4-hydroxyphenyl)-2,3-hexanediol, 5-methyl-1-(4-hydroxyphenyl)-3-hydroxy-2-hexanone, 5-methyl-1-(4-hydroxyphenyl)-2-hydroxy-3-hexanone, 4-methyl-1-(4-hydroxyphenyl)-3-hydroxy-2-hexanone, 4-methyl-1-(4-hydroxyphenyl)-2-hydroxy-3-hexanone, 5-methyl-1-(4-hydroxyphenyl)-2,3-hexanedione, 4-methyl-1-(4-hydroxyphenyl)-2,3-hexanedione, 4-methyl-1-(indole-3-)hexane, 5-methyl-1-(indole-3)-1-hexene, 5-methyl-1-(indole-3)-2-hexene, 5-methyl-1-(indole-3)-3-hexene, 4-methyl-1-(indole-3)-1-hexene, 4-methyl-1-(indole-3)-2-hexene, 4-methyl-1-(indole-3)-3-hexene, 5-methyl-1-(indole-3)-2-hexanol, 5-methyl-1-(indole-3)-3-hexanol, 4-methyl-1-(indole-3)-2-hexanol, 4-methyl-1-(indole-3)-3-hexanol, 5-methyl-1-(indole-3)-2-hexanone, 5-methyl-1-(indole-3)-3-hexanone, 4-methyl-1-(indole-3)-2-hexanone, 4-methyl-1-(indole-3)-3-hexanone, 5-methyl-1-(indole-3)-2,3-hexanediol, 4-methyl-1-(indole-3)-2,3-hexanediol, 5-methyl-1-(indole-3)-3-hydroxy-2-hexanone, 5-methyl-1-(indole-3)-2-hydroxy-3-hexanone, 4-methyl-1-(indole-3)-3-hydroxy-2-hexanone, 4-methyl-1-(indole-3)-2-hydroxy-3-hexanone, 5-methyl-1-(indole-3)-2,3-hexanedione, 4-methyl-1-(indole-3)-2,3-hexanedione, n-heptane, 1-heptene, 1-heptanol, heptanal, heptanoate, 2-heptene, 3-heptene, 2-heptanol, 3-heptanol, 4-heptanol, 2-heptanone, 3-heptanone, 4-heptanone, 2,3-heptanediol, 2,3-heptanedione, 3,4-heptanediol, 3,4-heptanedione, 2-hydroxy-3-heptanone, 3-hydroxy-2-heptanone, 3-hydroxy-4-heptanone, 4-hydroxy-3-heptanone, 2-methylheptane, 3-methylheptane, 6-methyl-2-heptene, 6-methyl-3-heptene, 2-methyl-3-heptene, 2-methyl-2-heptene, 5-methyl-2-heptene, 5-methyl-3-heptene, 3-methyl-3-heptene, 2-methyl-3-heptanol, 2-methyl-4-heptanol, 6-methyl-3-heptanol, 5-methyl-3-heptanol, 3-methyl-4-heptanol, 2-methyl-3-heptanone, 2-methyl-4-heptanone, 6-methyl-3-heptanone, 5-methyl-3-heptanone, 3-methyl-4-heptanone, 2-methyl-3,4-heptanediol, 2-methyl-3,4-heptanedione, 6-methyl-3,4-heptanediol, 6-methyl-3,4-heptanedione, 5-methyl-3,4-heptanediol, 5-methyl-3,4-heptanedione, 2-methyl-3-hydroxy-4-heptanone, 2-methyl-4-hydroxy-3-heptanone, 6-methyl-3-hydroxy-4-heptanone, 6-methyl-4-hydroxy-3-heptanone, 5-methyl-3-hydroxy-4-heptanone, 5-methyl-4-hydroxy-3-heptanone, 2,6-dimethylheptane, 2,5-dimethylheptane, 2,6-dimethyl-2-heptene, 2,6-dimethyl-3-heptene, 2,5-dimethyl-2-heptene, 2,5-dimethyl-3-heptene, 3,6-dimethyl-3-heptene, 2,6-dimethyl-3-heptanol, 2,6-dimethyl-4-heptanol, 2,5-dimethyl-3-heptanol, 2,5-dimethyl-4-heptanol, 2,6-dimethyl-3,4-heptanediol, 2,6-dimethyl-3,4-heptanedione, 2,5-dimethyl-3,4-heptanediol, 2,5-dimethyl-3,4-heptanedione, 2,6-dimethyl-3-hydroxy-4-heptanone, 2,6-dimethyl-4-hydroxy-3-heptanone, 2,5-dimethyl-3-hydroxy-4-heptanone, 2,5-dimethyl-4-hydroxy-3-heptanone, n-octane, 1-octene, 2-octene, 1-octanol, octanal, octanoate, 3-octene, 4-octene, 4-octanol, 4-octanone, 4,5-octanediol, 4,5-octanedione, 4-hydroxy-5-octanone, 2-methyloctane, 2-methyl-3-octene, 2-methyl-4-octene, 7-methyl-3-octene, 3-methyl-3-octene, 3-methyl-4-octene, 6-methyl-3-octene, 2-methyl-4-octanol, 7-methyl-4-octanol, 3-methyl-4-octanol, 6-methyl-4-octanol, 2-methyl-4-octanone, 7-methyl-4-octanone, 3-methyl-4-octanone, 6-methyl-4-octanone, 2-methyl-4,5-octanediol, 2-methyl-4,5-octanedione, 3-methyl-4,5-octanediol, 3-methyl-4,5-octanedione, 2-methyl-4-hydroxy-5-octanone, 2-methyl-5-hydroxy-4-octanone, 3-methyl-4-hydroxy-5-octanone, 3-methyl-5-hydroxy-4-octanone, 2,7-dimethyloctane, 2,7-dimethyl-3-octene, 2,7-dimethyl-4-octene, 2,7-dimethyl-4-octanol, 2,7-dimethyl-4-octanone, 2,7-dimethyl-4,5-octanediol, 2,7-dimethyl-4,5-octanedione, 2,7-dimethyl-4-hydroxy-5-octanone, 2,6-dimethyloctane, 2,6-dimethyl-3-octene, 2,6-dimethyl-4-octene, 3,7-dimethyl-3-octene, 2,6-dimethyl-4-octanol, 3,7-dimethyl-4-octanol, 2,6-dimethyl-4-octanone, 3,7-dimethyl-4-octanone, 2,6-dimethyl-4,5-octanediol, 2,6-dimethyl-4,5-octanedione, 2,6-dimethyl-4-hydroxy-5-octanone, 2,6-dimethyl-5-hydroxy-4-octanone, 3,6-dimethyloctane, 3,6-dimethyl-3-octene, 3,6-dimethyl-4-octene, 3,6-dimethyl-4-octanol, 3,6-dimethyl-4-octanone, 3,6-dimethyl-4,5-octanediol, 3,6-dimethyl-4,5-octanedione, 3,6-dimethyl-4-hydroxy-5-octanone, n-nonane, 1-nonene, 1-nonanol, nonanal, nonanoate, 2-methylnonane, 2-methyl-4-nonene, 2-methyl-5-nonene, 8-methyl-4-nonene, 2-methyl-5-nonanol, 8-methyl-4-nonanol, 2-methyl-5-nonanone, 8-methyl-4-nonanone, 8-methyl-4,5-nonanediol, 8-methyl-4,5-nonanedione, 8-methyl-4-hydroxy-5-nonanone, 8-methyl-5-hydroxy-4-nonanone, 2,8-dimethylnonane, 2,8-dimethyl-3-nonene, 2,8-dimethyl-4-nonene, 2,8-dimethyl-5-nonene, 2,8-dimethyl-4-nonanol, 2,8-dimethyl-5-nonanol, 2,8-dimethyl-4-nonanone, 2,8-dimethyl-5-nonanone, 2,8-dimethyl-4,5-nonanediol, 2,8-dimethyl-4,5-nonanedione, 2,8-dimethyl-4-hydroxy-5-nonanone, 2,8-dimethyl-5-hydroxy-4-nonanone, 2,7-dimethylnonane, 3,8-dimethyl-3-nonene, 3,8-dimethyl-4-nonene, 3,8-dimethyl-5-nonene, 3,8-dimethyl-4-nonanol, 3,8-dimethyl-5-nonanol, 3,8-dimethyl-4-nonanone, 3,8-dimethyl-5-nonanone, 3,8-dimethyl-4,5-nonanediol, 3,8-dimethyl-4,5-nonanedione, 3,8-dimethyl-4-hydroxy-5-nonanone, 3,8-dimethyl-5-hydroxy-4-nonanone, n-decane, 1-decene, 1-decanol, decanoate, 2,9-dimethyldecane, 2,9-dimethyl-3-decene, 2,9-dimethyl-4-decene, 2,9-dimethyl-5-decanol, 2,9-dimethyl-5-decanone, 2,9-dimethyl-5,6-decanediol, 2,9-dimethyl-6-hydroxy-5-decanone, 2,9-dimethyl-5,6-decanedionen-undecane, 1-undecene, 1-undecanol, undecanal, undecanoate, n-dodecane, 1-dodecene, 1-dodecanol, dodecanal, dodecanoate, n-dodecane, 1-decadecene, 1-dodecanol, ddodecanal, dodecanoate, n-tridecane, 1-tridecene, 1-tridecanol, tridecanal, tridecanoate, n-tetradecane, 1-tetradecene, 1-tetradecanol, tetradecanal, tetradecanoate, n-pentadecane, 1-pentadecene, 1-pentadecanol, pentadecanal, pentadecanoate, n-hexadecane, 1-hexadecene, 1-hexadecanol, hexadecanal, hexadecanoate, n-heptadecane, 1-heptadecene, 1-heptadecanol, heptadecanal, heptadecanoate, n-octadecane, 1-octadecene, 1-octadecanol, octadecanal, octadecanoate, n-nonadecane, 1-nonadecene, 1-nonadecanol, nonadecanal, nonadecanoate, eicosane, 1-eicosene, 1-eicosanol, eicosanal, eicosanoate, 3-hydroxy propanal, 1,3-propanediol, 4-hydroxybutanal, 1,4-butanediol, 3-hydrxy-2-butanone, 2,3-butandiol, 1,5-pentane diol, homocitrate, homoisocitorate, b-hydroxy adipate, glutarate, glutarsemialdehyde, glutaraldehyde, 2-hydroxy-1-cyclopentanone, 1,2-cyclopentanediol, cyclopentanone, cyclopentanol, (S)-2-acetolactate, (R)-2,3-Dihydroxy-isovalerate, 2-oxoisovalerate, isobutyryl-CoA, isobutyrate, isobutyraldehyde, 5-amino pentaldehyde, 1,10-diaminodecane, 1,10-diamino-5-decene, 1,10-diamino-5-hydroxydecane, 1,10-diamino-5-decanone, 1,10-diamino-5,6-decanediol, 1,10-diamino-6-hydroxy-5-decanone, phenylacetoaldehyde, 1,4-diphenylbutane, 1,4-diphenyl-1-butene, 1,4-diphenyl-2-butene, 1,4-diphenyl-2-butanol, 1,4-diphenyl-2-butanone, 1,4-diphenyl-2,3-butanediol, 1,4-diphenyl-3-hydroxy-2-butanone, 1-(4-hydeoxyphenyl)-4-phenylbutane, 1-(4-hydeoxyphenyl)-4-phenyl-1-butene, 1-(4-hydeoxyphenyl)-4-phenyl-2-butene, 1-(4-hydeoxyphenyl)-4-phenyl-2-butanol, 1-(4-hydeoxyphenyl)-4-phenyl-2-butanone, 1-(4-hydeoxyphenyl)-4-phenyl-2,3-butanediol, 1-(4-hydeoxyphenyl)-4-phenyl-3-hydroxy-2-butanone, 1-(indole-3)-4-phenylbutane, 1-(indole-3)-4-phenyl-1-butene, 1-(indole-3)-4-phenyl-2-butene, 1-(indole-3)-4-phenyl-2-butanol, 1-(indole-3)-4-phenyl-2-butanone, 1-(indole-3)-4-phenyl-2,3-butanediol, 1-(indole-3)-4-phenyl-3-hydroxy-2-butanone, 4-hydroxyphenylacetoaldehyde, 1,4-di(4-hydroxyphenyl)butane, 1,4-di(4-hydroxyphenyl)-1-butene, 1,4-di(4-hydroxyphenyl)-2-butene, 1,4-di(4-hydroxyphenyl)-2-butanol, 1,4-di(4-hydroxyphenyl)-2-butanone, 1,4-di(4-hydroxyphenyl)-2,3-butanediol, 1,4-di(4-hydroxyphenyl)-3-hydroxy-2-butanone, 1-(4-hydroxyphenyl)-4-(indole-3-)butane, 1-(4-hydroxyphenyl)-4-(indole-3)-1-butene, 1-di(4-hydroxyphenyl)-4-(indole-3)-2-butene, 1-(4-hydroxyphenyl)-4-(indole-3)-2-butanol, 1-(4-hydroxyphenyl)-4-(indole-3)-2-butanone, 1-(4-hydroxyphenyl)-4-(indole-3)-2,3-butanediol, 1-(4-hydroxyphenyl-4-(indole-3)-3-hydroxy-2-butanone, indole-3-acetoaldehyde, 1,4-di(indole-3-)butane, 1,4-di(indole-3)-1-butene, 1,4-di(indole-3)-2-butene, 1,4-di(indole-3)-2-butanol, 1,4-di(indole-3)-2-butanone, 1,4-di(indole-3)-2,3-butanediol, 1,4-di(indole-3)-3-hydroxy-2-butanone, succinate semialdehyde, hexane-1,8-dicarboxylic acid, 3-hexene-1,8-dicarboxylic acid, 3-hydroxy-hexane-1,8-dicarboxylic acid, 3-hexanone-1,8-dicarboxylic acid, 3,4-hexanediol-1,8-dicarboxylic acid, 4-hydroxy-3-hexanone-1,8-dicarboxylic acid, fucoidan or mixtures thereof.

Suitable microorganisms for carrying out the fermentation step would be known to someone skilled in the art and include yeast and/or a filamentaous fungus of a genus selected from Saccharomyces, Kluyveromyces, Candida, Pichia, Schizosaccharomyces, Hansenula, Kloeckera, Schwanniomyces, Yarrowia, Aspergillus, Trichoderma, Humicola, Acremonium, Fusarium and Penicillium. Bacteria, including but not limited to Clostridia, Klebsiella oxytoca stains, and E. coli strains may also be used.

The fermentation step is preferably carried out at a temperature and at a pH which are optimal for the fermentation microorganism and can be determined by someone skilled in the art. The fermentation step is typically carried out for a period of time sufficient to obtain the required quantity and/or yield of the desired organic molecule. In certain embodiments, the fermentation step is carried out for a period of time of at least 12 hours, preferably between about 12 and about 48 hours.

In a preferred embodiment, a fermentation inoculum is added to the hydrolysate, wherein the inoculum comprises dried baker's yeast, 1 g/L yeast extract, 0.5 g/L diammonium phosphate, 0.025 g/L magnesium sulphate and 1.38 g/L sodium dihydrogen phosphate. In a further preferred embodiment, a fermentation inoculum is added to the hydrolysate, wherein the inoculum comprises a concentration of 1 to 4 g of dried yeast per litre of hydrolysate. The temperature for the fermentation step may be between about 20° C. and about 75° C. and the pH may be from about pH 3.0 to about pH 9.0. The dissolved oxygen content is dependent on the strain and type of fermentation and may be less than 10% saturation. Supplemental nutrients may optionally be added and is dependent on strain and nutritional needs of specific organisms, which should be apparent to one skilled in the art.

After fermentation, at least one product or component of interest may be isolated and/or purified by any suitable technique known to one skilled in the art. The product or component is typically an organic molecule selected from the group consisting of alcohols, aldehydes, alkanes, alkenes, benzoic compounds, carboxylic acids, ketones, polyols. The outcomes of fermentation may be an organic molecule-rich aqueous phase and a solid phase. This mixture may be passed into a distillation unit that can be operated at either atmospheric pressure or any other pressure above or below atmospheric pressure and temperature conducive to the separation of the target organic molecule from other constituents in the process stream and can be determined by someone skilled in the art. The distillation unit may have multiple components including a beer column, rectifying column and stripping column and may be arranged in such a manner as to achieve the target organic molecule at a sufficiently high purity. There can be optionally a drying step in which a molecular sieve can be used to remove water from the process stream to provide a purity of about 97% to about 99.9%, more preferably about 99% to about 99.9%. An alternative method to distillation should the target organic molecule not be distillable for any reason may be used to purify the target organic molecule. An example of this could be through the use of solid phase separation followed by oil-aqueous phase separation.

In one embodiment, the purification step may involve filtering the fermented material through a filter cloth. The filtrate may be distilled at about 80° C. and the distillate containing the purified product collected for subsequent drying by passing through a molecular sieve.

Wherein the organic molecule of interest is ethanol, the process of the present invention will preferably produce ethanol of at least 99% purity, preferably 99.9% purity.

### Downstream Applications

The organic molecules produced by the process of the present invention may be used for any suitable downstream application. In preferred embodiments of the invention, the process is used to produce organic molecules, such as ethanol, that can be used to produce plastics or bio-plastics. As used herein, the term “bio-plastic” is intended to mean any plastic comprising polymers derived from a bio-based material including but not limited to alcohols, diols, alkanes, alkenes, carboxylic acids derived from plant biomass. Bio-plastics are of increasing interest because they represent an important alternative to plastics derived from non-renewable natural resources such as oil.

Polymers or bio-plastics may be manufactured from organic precursors comprising at least one organic molecule produced by the process of the present invention using any suitable techniques known to those skilled in the art. In one embodiment, the plastic produced is polyethylene terephthalate (PET), and the PET is produced by a process comprising the steps of:—
(a) taking ethanol produced by the process of the present invention;
(b) reacting with an oxygen source over a catalyst to produce ethylene;
(c) reacting with a source of steam of a catalyst to produce ethylene glycol; and
(d) heating with terephthalic acid to produce polyethylene terephthalate.

Bio-plastics produced from tobacco biomass using the process of the present invention may be used to manufacture a range of different products. In preferred embodiments of the invention, the bio-plastic produced is used in the manufacture of nicotine-containing products or nicotine-replacement products. Nicotine-containing products include nicotine inhalers, such as the simulated smoking device described in WO2011/095781.

As noted above, as tobacco smoking declines, the trend for nicotine replacement products, such as nicotine cartridges, nicotine inhalers and simulated smoking devices grows. However, many of these products require large quantities of plastic packaging and/or incorporate large quantities of plastic in their design. The process of the present invention allows for both the nicotine and an organic precursor of the plastic needed for plastic-containing nicotine replacement therapies and devices to be derived at least in part from the same tobacco biomass stock.

In view of the foregoing, provided herein is a nicotine replacement product comprising nicotine and a plastic synthesised at least in part from one or more organic precursors, wherein both the nicotine and at least one organic precursor are derived from the same tobacco biomass stock.

There are significant economic and environmental benefits to be gained from the presently-claimed process. The present invention would mitigate the loss of arable land in the cultivation of tobacco for smoking articles by deriving useful products, in addition to nicotine, from tobacco plants. Due to the high value of tobacco plants, in particular the leaves, when incorporated into smoking articles, a process for extracting nicotine and deriving organic precursors for the production of bio-based products such as plastics from the same biomass stock would not have previously been considered economically viable. However, in the long term, innovations such as nicotine replacement therapies could potentially decrease the market value of tobacco plants both in absolute terms, and relative to the value of purified nicotine. The present process, which utilises the entire tobacco plant for the extraction of components, particularly water-soluble components such as nicotine, and the production of organic molecules, such as alcohols, is therefore of significant commercial value.

The invention will be further understood with reference to the following non-limiting examples.

### Examples

### Example 1 Protocol for Nicotine Extraction and Ethanol Production Using Tobacco Biomass

### 1.1 Materials

Alkali: 0.5M sodium hydroxide (Sigma).
Tobacco Biomass: Nicotiana tabacum, with tobacco biomass defined as plant material containing at least: 25% Cellulose, 25% Hemicellulose, 15% lignin, and 0.1-5% Nicotine dry mass.
0.1 M Sulphuric acid (Sigma)
Citrate buffer (Sigma)
Paraffin (Sigma)
Baker's yeast (S cerevisiae)
Inoculum media (10×)
   6.7 g/L Yeast Nitrogen Base (Difco)
   5 g/L Dextrose (Difco)
Enzymes: Cellulase, Cellic Ctec2 and Htec2 (Novozyme)
Media supplement, calculate such that the final fermentation broth has the following concentrations.
   1 g/L yeast extract (Difco)
   0.5 g/L diammonium phosphate (Sigma).
   0.025 g/L magnesium sulphate (Sigma).
   1.38 g/L sodium dihydrogen phosphate (Sigma).
Filter cloth/Gauze (Fisher)
Thermocouple (Cole Parmer)
Water baths+heating plates (Cole Parmer)
1× pressure vessel (Merrow Scientific)
1× fermenter (Cole Parmer)
General laboratory equipment: beakers, pipettes, stirrers, pH meter, balance
Sterile balance in sterile hood
Dissolved oxygen probe (Mettler Toledo)
Distillation and vacuum distillation equipment (Sigma)
Personal protective equipment.

### 1.2 Biomass Collection

Tobacco biomass is harvested for processing from topped mature tobacco plants. The biomass is washed thoroughly with water to remove residual soil and water-soluble non-systemic agents used during cultivation.

### 1.3 Pre-Treatment

Prior to pre-treatment, the tobacco biomass is shredded into pieces of <10 mm to allow for better access of reagents and extraction of nicotine. The weighed, shredded biomass is pre-loaded into a pressure vessel. The sodium hydroxide solution (0.5M) is added to the pressure vessel to obtain a final dilution of 12% w/w solid content. While agitating the mixture, the pressure vessel is heated to an operating temperature of 120° C., and maintained at this temperature for 10 minutes. The temperature of the reactor is cooled to 50° C. for safe handling of pretreated material.

### 1.4 Nicotine Separation

The pre-treated material is filtered through several layers of filter cloths to separate the solids. The liquid filtrate is collected in a container. The solid residue is washed with small amounts of water 3 times to extract as much nicotine as possible into the container. Paraffin is added to the filtrate and mixed well. The mixture is centrifuged at 3000 g for 5 minutes to separate the two phases. The hydrophobic phase (paraffin phase) is collected.

0.1M sulphuric acid solution is added to the paraffin phase and mixed well. The mixture is centrifuged at 3000 g for 5 minutes to separate the two phases. The acidic phase is collected and neutralised with 0.1 M sodium hydroxide solution. The solution is distilled at 125° C. at 101 kPa to remove water. The solution is then vacuum distilled at 125° C. at 1.6 kPa and purified nicotine is collected from the condenser. The purity of the product can be determined by HPLC.

### 1.5 Enzyme Treatment and Fermentation

The solid material from the filtration is autoclaved at 121° C. for 15 min. In a sterile hood, the autoclaved solid material is weighed and aseptically transferred to the fermentation reactor.

Water at 50° C. is added to the fermentation reactor to obtain a final dilution of 10% w/w solid content. The temperature is maintained at 50° C., while the mixture is adjusted to pH5 with 0.1M sulphuric acid. Citrate buffer at 50° C. and pH 5, is added to a final concentration of 0.1M. Hydrolytic enzymes are added in a ratio of 1:10 w/w enzymes: solids. The reaction is allowed to proceed for 24 hours, with stirring for the duration of the reaction. After 24 hours, the reactor is cooled to 30° C., and this temperature is maintained for the fermentation.

A fermentation inoculum is prepared by resuspend the dried yeast in the inoculum media, and growing at 30° C. for 4-12 hrs. The reactor is then inoculated with the yeast inoculum equivalent to 1-4 g dried yeast/L fermentation broth. The media supplement is added to the fermentation broth. The fermentation is run for 12-48 hours with stirring to achieve proper mixing. The pH is monitored throughout fermentation and should be in the range of pH 4-5.5. During fermentation, the dissolved oxygen is checked and if required, the air is sparged to maintain hypoxic conditions (<10% saturation Dissolved Oxygen the saturation point is 0.2 mM).

### 1.6 Ethanol Purification

The fermentation broth is passed through a filter cloth to remove all solids. The filtrate is distilled at 101 kPa at 80° C. and recycled until 95% pure. Distil through a zeolite, molecular sieve, to remove the remaining water present in the primary distillate to give ethanol with purity of 99.9%.

The purity of the ethanol can be determined via gas chromatography.

The 99.9% pure ethanol is reacted with 90% oxygen over a silver catalyst at 220-280° C. and subsequently passed through an aluminium oxide catalyst with excess steam to produce ethylene glycol. The ethylene glycol can then be mixed with terephthalic acid in a heating vessel and heated up to 270° C. to produce polyethylene terephthalate.

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims. Moreover, all aspects and embodiments of the invention described herein are considered to be broadly applicable and combinable with any and all other consistent embodiments, including those taken from other aspects of the invention (including in isolation) as appropriate.

Various publications are cited herein, the disclosures of which are incorporated by reference in their entireties.

1. A process for deriving two or more components or products from tobacco biomass stock, wherein at least one component or product is extracted from a liquid phase, and at least one component or product is produced from a solid phase, wherein said process comprises the steps of:
(a) treating the biomass stock with an aqueous alkali solution to produce a liquid phase and a solid phase containing undissolved tobacco cellulosic material;
(b) separating the liquid phase from the solid phase;
(c) extracting the at least one component or product from the liquid phase by liquid-liquid or solid phase extraction;
(d) contacting the solid phase with one or more enzymes capable of hydrolyzing the cellulosic material to produce fermentable sugars; and
(e) fermenting the fermentable sugars to produce the at least one component or product from the solid phase.

2. The process of claim 1, wherein the component or product extracted from the liquid phase is water-soluble.

3. The process of claim 2, where the water-soluble component or product is selected from the group consisting of: alkaloids, citric acids, pectins, carotenoids, pectinases, fraction 1 proteins, fraction 2 proteins, and phenolic compounds.

4. The process of claim 2, wherein the water-soluble component or product is nicotine.

5. The process of claim 1, wherein the component or product produced from the solid phase is an organic molecule selected from the group consisting of:—alcohols, aldehydes, alkanes, alkenes, benzoic compounds, carboxylic acids, ketones, polyols.

6. The process of claim 5, wherein the organic molecule is an alcohol.

7. The process of claim 6, wherein the organic molecule is ethanol.

8. The process of claim 1, wherein prior to step (a), the biomass stock is treated so as to recover an oil-soluble component or product.

9. The process of claim 8, wherein the oil-soluble component or product is selected from the group consisting of: solanesol and polyprenols.

10. The process of claim 1, wherein the tobacco biomass stock comprises plants or parts thereof from species of the Nicotiana genus.

11. The process of claim 1 herein the tobacco biomass stock comprises at least 0.1% w/w nicotine.

12. The process of claim 11, wherein the tobacco biomass stock additionally comprises at least 25% w/w cellulose.

13. The process of claim 12, wherein the tobacco biomass stock additionally comprises at least 15% w/w hemicellulose and at least 10% w/w lignin.

14. The process of claim 1, wherein the aqueous alkali solution has a concentration of between about 0.1 M and about 1.0 M.

15. The process of claim 1, wherein in step (a), the biomass-aqueous alkali solution is treated at a temperature of between about 100° C. and about 200° C.

16. The process of claim 15, wherein the solution is treated at a temperature of about 120° C.

17. The process of claim 1, wherein in step (a), treatment is carried out for a period of time between about 2 minutes and about 120 minutes.

18. The process of claim 17, wherein treatment is carried out for about 10 minutes.

19. The process of claim 1, wherein the aqueous alkali solution is added to the biomass so as to achieve a final dilution of between about 5% w/w and about 25% w/w solid content.

20. The process of claim 1, wherein the aqueous alkali solution is a sodium hydroxide solution.

21. The process of claim 1, wherein in step (b), the liquid phase is separated from the solid phase by filtering the treated tobacco biomass stock.

22. The process of claim 1, wherein the at least one component or product extracted in step (c) is nicotine and the at least one component or product produced in step (e) is ethanol.

23. The process of claim 22, wherein the extracted nicotine is of at least 95% purity and the ethanol produced is of at least 99% purity.

24. A process for the production of polyethylene terephthalate wherein the process comprises the steps of:
(a) taking ethanol produced by the process of claim 1;
(b) reacting with an oxygen source over a catalyst to produce ethylene;
(c) reacting with a source of steam of a catalyst to produce ethylene glycol; and
(d) heating with terephthalic acid to produce polyethylene terephthalate.

25. A polymer synthesised at least in part from one or more organic precursors comprising at least one organic molecule produced by the process of claim 1.

26. A plastic synthesised from the polymer of claim 25.

27. A nicotine replacement product comprising the plastic of claim 26.

28. A nicotine replacement product comprising nicotine and a plastic synthesised at least in part from one or more organic precursors, wherein both the nicotine and at least one organic precursor are derived from the same tobacco biomass stock.
